(19) United States
(12) Patent Application Publication
(10) Pub. No.: US 2025/0348441 A1
(43) Pub. Date: Nov. 13, 2025

(54) PROGRAMMATIC CONTROL OF DEVICE I/O; EMF QUIET MODE, ZONE, SIGNALING, AND PROTOCOL

(71) Applicant: Francis J. LEAHY, Mill Valley, CA (US)

(72) Inventor: Francis J. LEAHY, Mill Valley, CA (US)

(21) Appl. No.: 19/269,661

(22) Filed: Jul. 15, 2025

Related U.S. Application Data
(63) Continuation-in-part of application No. 18/295,892, filed on Apr. 5, 2023, now Pat. No. 12,393,528.
Application No. 18/295,892 is a continuation of application No. 17/397,643, filed on Aug. 9, 2021, now Pat. No. 11,625,340.
Application No. 17/397,643 is a continuation of application No. 17/008,192, filed on Aug. 31, 2020, now Pat. No. 11,106,603.

(51) Int. Cl. G06F 13/12; G06F 13/42

(52) U.S. Cl. CPC G06F 13/122; G06F 13/4282; G06F 2213/0042

(57) ABSTRACT

Programmatic control of device I/O for both EMF reduction and attention regulation is disclosed. A device I/O controller application enables management of the device's I/O channels in response to control rules that may be static or dynamic, or dynamically inferred by AI models. These controls reduce EMF emissions and help manage cognitive burden by regulating attention disrupting activity at both the system and application levels. App-level mediation capabilities allow suppression of specific behaviors such as autoplay, message alerts, and background media playback during periods of focus or rest. A quiet mode, administered by an administrator, governs I/O settings to create a quiet zone. Within this zone, some or all nearby devices respond to a signaling protocol by entering a quiet state, thereby minimizing EMF output and reducing sensory or cognitive interruptions associated with device connectivity.

### CROSS-REFERENCE TO RELATED APPLICATIONS

This application is a continuation-in-part application of U.S. application Ser. No. 18/295,892, filed on Apr. 5, 2023, which is a continuation application of U.S. application Ser. No. 17/397,643, filed on Aug. 9, 2021 (now U.S. Pat. No. 11,625,340), which is a continuation of U.S. application Ser. No. 17/008,192, filed on Aug. 31, 2020 (now U.S. Pat. No. 11,106,603), the disclosures of which are incorporated by reference herein in their entireties.

### TECHNICAL FIELD

Various of the disclosed embodiments concern programmatic control of device I/O, and electromagnetic field or electromagnetic frequency (EMF) and attention-regulating quiet mode, zone, signaling, and protocol.

### BACKGROUND

Some individuals are electromagnetic field or electromagnetic frequency (EMF) sensitive, and many others prefer to reduce their EMF exposure, as well as that to their family or others around them. For example, whenever anyone enters such an individual's house, or when the individual is in a car with others, they may ask these others to set their phones to airplane mode so that the device is no longer sending and receiving wireless signals, e.g. cellular, Bluetooth, Wi-Fi, etc. Such individuals may also make their home as EMF quiet as possible in this day of ubiquitously connected devices, e.g. they may decide not to have Wi-Fi enabled in their house, and they may connect some or all of their devices, including their mobile devices, to the Internet via hard-wired ethernet or similar cables.

EMF radiation is a bigger problem than for just people who are EMF sensitive. EMF exposure during pregnancy has been associated with significantly increased miscarriage risk (up to 2.72 times higher in some studies) and may be linked to various developmental concerns, including potential impacts on fetal brain development. EMF is a problem for young men whose sperm has been shown to be both severely damaged, and significantly reduced, by wireless radiation exposure. EMF is a problem for babies and children because their skulls are thinner, which means that their exposure is up to two times higher in the brain, and ten times higher in the bone marrow of the skull, versus that encountered with mobile phone use by adults. EMF is also a problem for animals and insects, particularly bees whose behavior and physiology are influenced by radiation from cell towers. Further, cell tower radiation can disrupt the magnetic compass that bees and migrating birds use for navigation.

There are other reasons why people might want to control their phone's activity—not merely by enabling airplane mode, but through more nuanced, programmable control of connectivity and other input/output (I/O) channels—not only to reduce EMF exposure, but to also prevent interruptions and support focused or restful periods. For example, in this age of constant interruptions, it can be useful to be able to create time and space where interruptions are impossible, or at least reduced, such as while thinking, writing, playing music, on a hike, or sharing a meal with family or friends. These interruptions are not solely an issue of EMF exposure-they also represent a growing cognitive and psychological burden, especially for young users. Accordingly, another important use case for programmatic I/O control is the protection of attention, and reduction of cognitive overload, as described in the following paragraphs.

A personal mobile device, such as an iPhone, is just one of many EMF generating and attention-diverting devices with which we interact on a daily basis, whether we know it or not. We are surrounded by Wi-Fi routers and repeaters, computers, laptops, hubs, routers, Xboxes, PlayStations, cell phone repeaters, smart homes, smart meters, Wi-Fi enabled thermostats, Bluetooth and Wi-Fi enabled baby monitors, home security cameras, etc. There is also the phone in the pocket of the person sitting next to you at Starbucks, the Wi-Fi router hidden in the closet of the Airbnb you're renting, and the smart car software that's running in your rental car. All of these things, and more, are adding to an ever more crowded EMF and attention disrupting landscape.

### SUMMARY

Programmatic control of device input/output (I/O), and electromagnetic field or electromagnetic frequency (EMF) and attention-regulating quiet mode, zone, signaling, and protocol is disclosed.

Programmatic device I/O control reduces EMF radiation and supports attention regulation by limiting unnecessary device interactions, interruptions, and cognitive load. A device with a device I/O controller application enables programmatic control of the device's I/O channels. Responsive to firing of control rules, the device I/O application calls device APIs to control I/O channel settings.

A quiet mode that reduces overall EMF radiation and reduces attention disrupting activity from a device is administered by an administrator and controls the device's I/O channels to create a quiet zone in which some or all devices in a vicinity respond to a request to put themselves into an EMF and attention-regulating quiet mode.

While much of the present specification discusses the control of device I/O channels in the context of reducing EMF radiation, the same systems and processes described herein are equally applicable to the management of digital attention and cognitive load, especially for children and adolescents. In particular, frequent device interruptions, persistent notifications, background app activity, and unlimited access to communication and entertainment platforms have been identified in behavioral science literature as major contributors to distraction, decreased focus, sleep disruption, and mental health challenges. These harms arise not from the EMF itself, but from the interaction patterns and cognitive demands imposed by constant connectivity.

Accordingly, in addition to EMF reduction, the programmatic control of device I/O described in this patent supports an attention regulation use case, where device I/O channels are controlled to reduce cognitive interruption, and protect periods of focused attention, rest, or social presence. In this context, “quiet mode” may refer not only to a reduction in EMF activity but also to a reduction in sensory and cognitive input from apps and services arising from device usage and connectivity.

As such, the same rules-based control system—using time-, location-, voice-, sensor-based triggers, etc.—can be applied to enforce periods of device silence or restricted function for the purposes of attention regulation. This includes, but is not limited to muting social media and messaging apps during school hours; limiting video playback or game access during study periods; and enabling device quieting in group settings (e.g., family meals, classrooms, counseling sessions) to create attention regulated environments. This expanded use case remains within the scope of the embodiments, which broadly concerns programmatic control of device input and output channels for user-defined, health-related, and context-aware goals.

### BRIEF DESCRIPTION OF THE DRAWINGS

FIG. 1 is a block diagram showing a user device and device input/output (I/O) controller application.

FIG. 2 is a block diagram showing device administration.

FIG. 3 is a block diagram showing corporate device administration.

FIG. 4 is a block diagram showing an EMF quiet zone.

FIG. 5 is a block diagram showing administration of an EMF quiet zone capable device.

FIG. 6 is a block diagram that shows signaling in EMF quiet zones.

FIG. 7 shows a diagrammatic representation of a machine in the example form of a computer system within which a set of instructions for causing the machine to perform one or more of the methodologies discussed herein may be executed.

FIG. 8 is a block diagram that illustrates an example AI system that can implement aspects of the present technology.

FIG. 9 is a block diagram showing a user device and device I/O controller application.

FIG. 10 is a block diagram showing device administration.

FIG. 11 is a block diagram showing corporate device administration.

FIG. 12 is a block diagram showing administration of a quiet zone capable device.

FIG. 13 is a block diagram that illustrates an example of a computer system in which at least some operations described herein can be implemented.

### DETAILED DESCRIPTION

### Terminology

References in the present disclosure to “an embodiment” or “some embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the terms “comprise,” “comprising,” and “comprised of” are to be construed in an inclusive sense rather than an exclusive or exhaustive sense. That is, in the sense of “including but not limited to.” The term “based on” is also to be construed in an inclusive sense. Thus, the term “based on” is intended to mean “based at least in part on.”

The terms “connected,” “coupled,” and variants thereof are intended to include any connection or coupling between two or more elements, either direct or indirect. The connection or coupling can be physical, logical, or a combination thereof. For example, elements may be electrically or communicatively coupled to one another despite not sharing a physical connection.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing all tasks.

When used in reference to a list of multiple items, the word “or” is intended to cover all of the following interpretations: any of the items in the list, all of the items in the list, and any combination of items in the list.

For purposes of the discussion herein, airplane mode refers to the ability to control device input/output (I/O) channels-such as wireless radios, cameras, microphones, screens, speakers, haptics, and other sensors-regardless of whether they are networked, wired, or local.

As used herein, “quiet mode” may refer to a configurable state of a device where one or more I/O channels are programmatically controlled-turned off, limited, or adjusted-based on predefined rules, context, or user preferences.

For the purposes of this disclosure, the terms “airplane mode,” “quiet mode,” and “device quiet mode” are used interchangeably and refer to the capability to programmatically control some or all of a device's I/O channels.

The terms “EMF quiet zone,” “EMF quiet mode,” “EMF protocol,” and “EMF signaling” are to be understood as encompassing “EMF and attention-regulating quiet zone,” “EMF and attention-regulating quiet mode,” “EMF and attention-regulating protocol,” and “EMF and attention-regulating signaling” respectively. These terms may also be used interchangeably with the generalized terms “quiet zone,” “quiet mode,” “protocol,” and “signaling” where the context so indicates.

For the purposes of this disclosure, the term “API” refers to any means of controlling I/O channels, such as by using application programming interfaces, device driver interfaces, firmware interfaces, hardware interfaces, or other interfaces, and via any of network, electrical, mechanical, sound, quantum, light or similar signals or control mechanisms.

As used herein, “device I/O” and “device I/O channels” may refer to any mechanisms or subsystems through which a device receives input or delivers output, including physical or virtual interfaces, sensors, actuators, and communication pathways. Device I/O channels may include, but are not limited to cellular, Wi-Fi, Bluetooth, NFC, USB, HDMI, Ethernet, microphone, speaker, camera, display, touchscreen, GPS, accelerometer, gyroscope, vibration motor, or notification or status indicators (e.g., LEDs, screen flashes, or edge lighting).

As used herein, “throttle” may refer to the act of intentionally limiting or reducing the performance, speed, or functionality of a device I/O channel or system component to achieve specific operational goals or constraints.

As used herein, “policy” may refer to a set of rules, guidelines, or configurations that govern the behavior, operation, or management of device I/O channels, applications, or system components in specific contexts or conditions.

As used herein, “template” may refer to a predefined set of rules, settings, or configurations that can be applied to one or more devices or user profiles to quickly implement consistent I/O control behaviors across multiple instances.

As used herein, “profile” may refer to a collection of settings, preferences, and rules associated with a specific user, device, or context, which determines how device I/O channels and applications behave under various conditions.

### Programmatic Control of Device I/O

The disclosed embodiments concern control of a phone's I/O channels, including—but not limited to—the type of functionality provided by airplane mode. For clarity, device “quiet mode” refers to a configurable state in which one or more of a device's I/O channels (such as cellular, Wi-Fi, Bluetooth, USB, HDMI, microphone, speaker, camera, notifications, etc.) are programmatically controlled-turned off, limited, or adjusted-based on time, location, activity, administrative rules, etc. Device quiet mode may be used to reduce EMF radiation, manage digital interruptions, protect user attention, conserve battery, or comply with institutional or location-specific policies. This definition expands beyond traditional airplane mode to support broader and more adaptive control scenarios.

The disclosed embodiments also concern control of a phone's device I/O channels, e.g. via airplane mode, so that instead of the phone being “on” all the time, it would check for incoming messages on a schedule, e.g. every 10 minutes, or every hour, so that it is “off” most of the time. This reduced schedule of operation correspondingly reduces the EMF radiation and attention disruptions from the phone by 95% and more.

However, neither APPLE (iOS) nor ANDROID provide a developer-accessible API to much of the device I/O: e.g., not for Wi-Fi, Bluetooth, or cellular I/O, or for control of device I/O across some or all applications, e.g. camera, video, microphone, or notifications, etc. The fact that the API is currently inaccessible does not mean that providing an application for controlling it is not a good idea, or incapable of reduction to practice.

### Device I/O Controller Application

Embodiments provide an application, i.e. the device I/O controller, that controls any or all of a device's I/O channels. I/O channels include both low-level device I/O, such as the cellular network, Wi-Fi, Bluetooth, etc., as well as higher-level device I/O, such as camera, microphone, speaker, video, phone, text, email, Internet, games, music, video, etc. Channels can be wired or wireless.

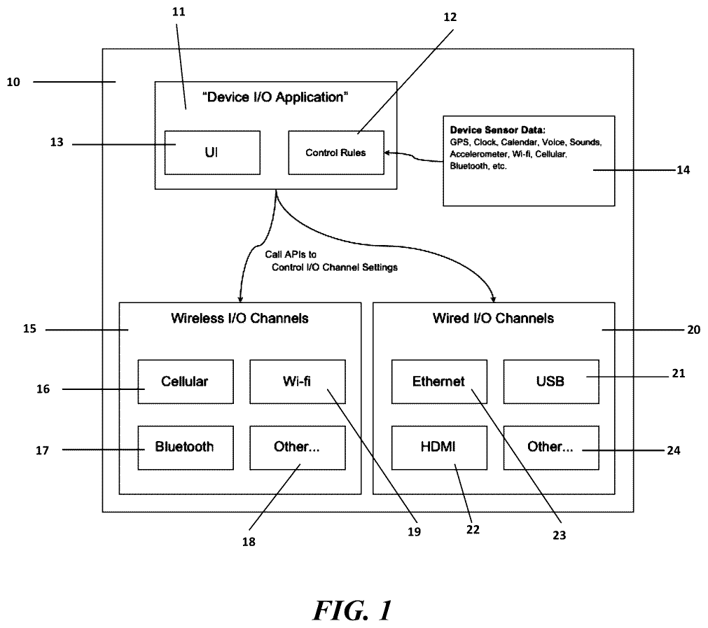

FIG. 1 is a block diagram showing a user device and device I/O controller application. In FIG. 1, a device 10 includes a device I/O application 11, which includes a user interface 13 and a set of control rules 12. The control rules are fired, for example, based on device sensor data 14. The device I/O application calls device APIs to control I/O channel settings, e.g. for wireless I/O channels 15 for cellular 16, Bluetooth 17, Wi-Fi 19, and other 18 facilities, and to control wired I/O channels 20 for ethernet 23, USB 21, HDMI 22, and other 24 facilities.

Controls are rules-based, and can include, but are not limited to, the following types of rules:
Time-based rules: For example, the device defaults to an established schedule, e.g. check once an hour, but check every ten minutes during work hours; do not check between 10 pm and 7 am, while the user is asleep, or during family dinner time; do not check on Sunday; etc.
Location-based rules: For example, check every ten minutes at work, but only check every hour at home; do or do not check when the user is walking at a location associated with recreation or exercise; do or do not check when the user is visiting friends whose locations have been added to the app; etc.
Activity-based rules: For example, turn off everything except the ability to make and receive phone calls while exercising (GPS and/or motion could be used to determine this); turn off everything except the Wi-Fi while the user is flying (GPS height and speed information could be used to determine this);
turn off everything while the user is meditating or while using a meditation app; turn off everything when the user turns the phone upside down on a table; etc.
Voice-based: For example, the user could say “Turn off for the next hour;” “Check now;” “Turn off until tomorrow morning at 8 am”; etc.
Country defaults: Some countries, such as France, have laws that do not allow emails to be received between certain hours and on certain days. The application could be programmed to use country-based rules as a baseline.
Sensor-based rules: Rules triggered by internal and external inputs such as ambient light, night shift mode, orientation, accelerometer data, nearby sounds, or proximity to others.
User age and category: Rules may be adapted based on user profile information such as age, grade level, or role (e.g., child, teenager, student, adult, teacher, guest), as assigned by a parent, school, or administrator.
App store data and metadata: Rules may use application data and metadata (such as App Store age ratings, content type, or parental guidance flags) to restrict or modify I/O access to certain applications or categories of applications.
Application download attempts: The system may intercept application installation attempts and apply controls-such as allowing, denying, or prompting for approval-based on user profile, app metadata, or time-of-day and location-based policies.
Other rules: Embodiments may use other internal and external inputs to define rules which control the device, for example group behavior based rules, crowd and density aware rules, or use of I/O devices and channels not currently used or invented.

In some embodiments, the control rules are not solely predefined, but are dynamically inferred or optimized using AI models trained on user behavior, location patterns, and feedback. These models may detect patterns in attention disruption or EMF exposure, and suggest or auto-adapt rule templates (e.g., quiet hours, high-distraction zones) based on real-time or historical data.

AI models can also be employed to detect and classify contextual cues, such as identifying when a user is in a “deep work” state, in a classroom, or socially engaged, by analyzing device sensor inputs (e.g., accelerometer, app usage, ambient audio, typing cadence). This enables intelligent, adaptive enforcement of quiet modes without manual configuration.

In some embodiments, the device I/O controller application extends beyond system-level I/O channels to mediate behaviors within applications themselves. This includes the ability to suspend or suppress specific app functionalities such as autoplay video, push notifications, message alerts, location polling, or background media playback.

App-level mediation may be achieved through OS-level accessibility frameworks, app permission toggling, or system-level enforcement policies that control how and when an app may access system resources. These controls may be informed by app metadata, usage history, app category, or user-defined rules (e.g., “disable autoplay for video apps during study hours”).

### Controlling Other Devices

Whether we know it or not, we are surrounded by a plethora of EMF emitting and attention demanding devices, such as Wi-Fi routers and extenders, computers, laptops, hubs, routers, Xboxes, PlayStations, cell phone repeaters, smart homes, smart meters, Wi-Fi enabled thermostats, Bluetooth and Wi-Fi enabled baby monitors, and home security cameras. A natural extension of the ability to control our personal mobile device is the ability to control other devices which we own or have the ability to control. In embodiments, the same device I/O controller application which is used to control the mobile phone on which it is installed can be enhanced to configure and control any of the other devices to which we have physical or virtual access.

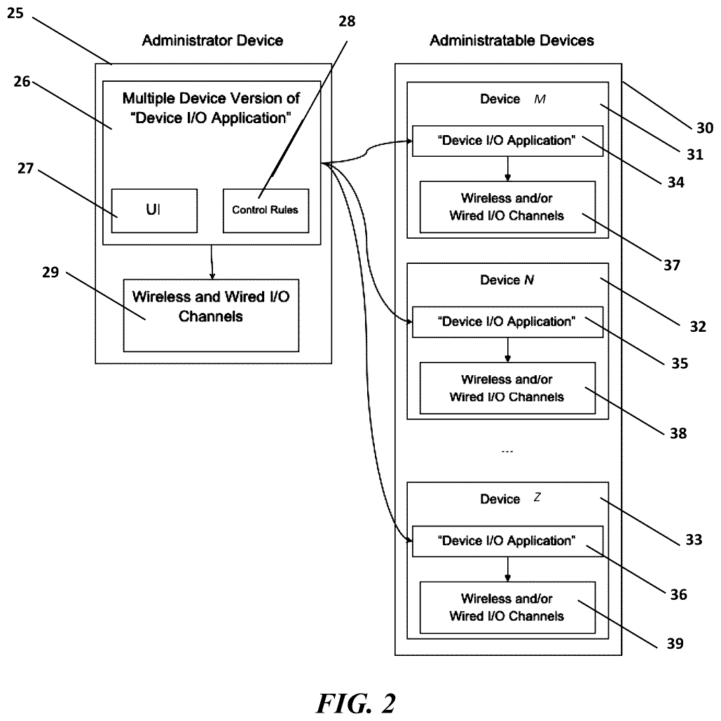

FIG. 2 is a block diagram showing device administration. In FIG. 2, an administrator device 25 includes a multiple-device version of the device I/O application 26, which includes a user interface 27 and a set of control rules 28 which it stores in its memory. The control rules are fired, for example, based on device sensor data (see FIG. 1) or other data.

The administrator device then addresses, and sends commands to, the various administrable devices 30, for example devices M-Z (31, 32, 33) each of which includes a respective device I/O application (34, 35, 36) and respective wireless and wired I/O channels (37, 38, 39).

Devices and users can be placed into categories such as “child” or “parent,” “phone” or “laptop.” Rules-based controls can be set up and applied to specific categories such as [“child” and “phone”], or to combinations of categories such as [“child” or “phone”]. Controls can use any of the same rules-based criteria as defined above. Rules are delivered to devices via standard Internet protocols, such as TCP/IP, and each device's acknowledgment and current settings can be displayed by the application.

### Corporate Version

The device I/O controller application can be enhanced to allow devices belonging to a corporation, or other entity, to be controlled by an administrator. The administrator can classify and characterize devices based on characteristics such as “device type,” e.g. iPhone, tablet, laptop, etc., or “device category,” e.g. library device, lab device, personal device, etc., as well as to classify and categorize users. For example, a school might define user categories such as “administrators,” “teachers,” “students,” “staff,” and “guests,” while a corporation might define user categories such as “executives,” “legal,” “IT,” “site reliability,” “engineering,” “accounting,” etc.

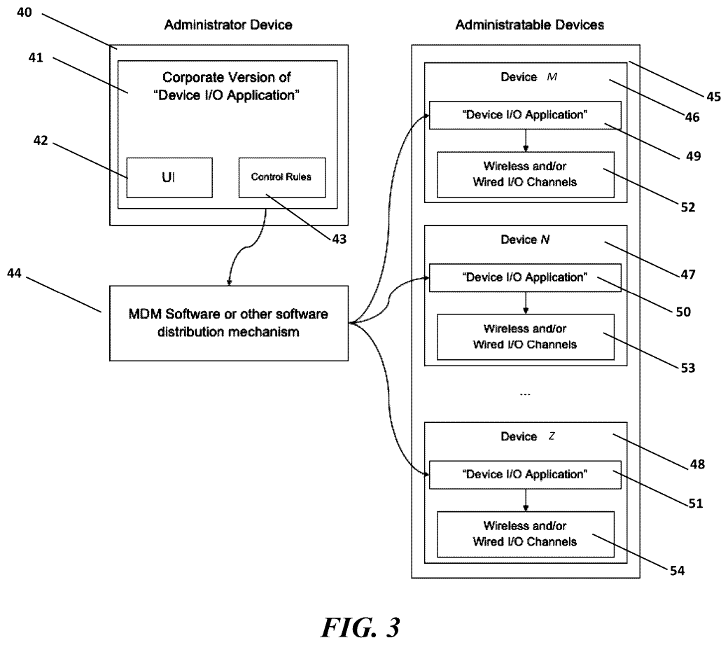

FIG. 3 is a block diagram showing corporate device administration. In FIG. 3, an administrator device 40 includes a corporate version of the device I/O application 41, which includes a user interface 42 and a set of control rules 43. The control rules are fired, for example, based on device sensor data (see FIG. 1) or other data. The device I/O application communicates with a software distribution system 44, such as mobile data management (MDM) software. The software distribution system addresses various administrable devices 44, and it sends commands to, for example, devices M-Z (46, 47, 48), each of which includes a respective device I/O application (49, 50, 51) and respective wireless and wired I/O channels (52, 53, 54).

Devices and users can be part of one or more types or categories. Controls and rules can be assigned on a gross basis, to all devices, or on a fine-grained basis, to any combination of device and/or user, type and/or category. When a device/user is part of more than one type or category, the administrator can decide whether the rules to be used on the device are the most or least restrictive of all of the applicable rules. Rules can also be delivered via corporate MDM software.

In enterprise or educational settings, administrators may define policies that suppress disruptive app behaviors across managed devices, including disabling chat and chat alerts during school hours, pausing autoplay on video platforms, or deferring all notifications for specific user groups. These policies may be enforced via the device I/O controller or through integration with mobile device management (MDM) tools.

In enterprise or school deployments, AI can aggregate anonymized usage data across similar user categories to recommend effective rule sets (e.g., schools like yours applied the following policy template to students). Collaborative filtering or clustering techniques can be used to assist administrators in choosing effective I/O governance policies.

### EMF and Attention-Regulating Quiet Mode, Zone, Signaling, and Protocol

We are surrounded by Wi-Fi routers and repeaters, computers, laptops, hubs, routers, Xboxes, PlayStations, cell phone repeaters, smart homes, smart meters, Wi-Fi enabled thermostats, Bluetooth and Wi-Fi enabled baby monitors, home security cameras, etc. Embodiments, in addition to controlling personal mobile devices, can also control some or all of these other devices as well.

Such control concerns two things: knowing which devices in the vicinity are in or out of quiet mode, and of those which are controllable; and changing the I/O settings of those devices, so that they are throttled or off, or connecting less frequently and, in doing so, reducing the amount of EMF and attention disruption while one is in the vicinity of these devices. For example, if a user has a Wi-Fi router at home, such control would mean knowing whether it was on or off, and then having the ability to tell it to turn on or off. Control could mean being able to turn all of the children's phones to quiet mode while they are doing homework, turn all of the family's phones to quiet mode during family dinner time, and also after 10 pm at night. It could mean telling the smart meter to send out data only once an hour, rather than every 30 seconds as it does now. It could mean temporarily quieting the phones of those in a theater, or at a lecture.

An extension of controlling devices that one has access to is the ability to control devices in a particular setting or location. Schools want to know that student phones are not being used during class. Hospitals want mobile devices to be in quiet mode in certain parts of the hospital, so they do not interfere with important equipment. Airlines would like to be sure that passenger phones are in airplane mode during take-off and landing. A corporation might want to ensure that Bluetooth is turned on (or off) on all phones which are taken into specific buildings.

### EMF Quiet Mode and EMF Quiet Zone

In 25 years, we will likely think of EMF radiation and constant attention disruptions in much the same way that we think of smoking. Seventy years ago, smoking was ubiquitous. It was in the air around us, everyone did it, no one complained about the health issues, and if someone did complain they were thought to be a little bit crazy. Then things started to change, first with the 1964 Surgeon General's report, and finally, in 1995, California became the first state to ban smoking indoors. The same progression is likely to happen with EMF and attention disruptions where, in the not too distant future, places such as restaurants, churches, hospitals, parks, and day care centers will start displaying a Quiet Zone sticker showing that the people in that location prefer to have their devices in quiet mode as much as possible. For the purposes of the discussion herein, two concepts are defined:

Quiet mode may refer to the ability to control a single device's I/O channels for the purpose of reducing EMF levels.

A Quiet Zone (or quiet space) is a place where devices are expected to, are able to, and are willing to, subscribe to a set of rules defined by the administrator of the EMF quiet zone. The rules specify how “quiet” the zone is, and can range anywhere from fully quiet/all I/O channels off, to preferred check interval is five minutes, to parents with children can check every two minutes while all others can check once an hour, to no restrictions from 1 pm-5 pm, or any other set of rules as defined by the administrator.

In short, quiet mode applies at the device level, while quiet zone applies at the environmental or contextual level.

### Quiet Mode

The purpose of defining an EMF and attention-regulating quiet mode is to reduce overall EMF exposure, reduce interruptions, save battery life, and be in control of our devices instead of them being in control of us. Any devices, such as phones, Wi-Fi routers, cellular repeaters, etc., could support quiet mode, either actively, i.e., the device understands the concept of quiet mode and is able and willing to be controlled, or passively, i.e. the device does not understand the concept of quiet mode but can still be programmed to throttle or turn I/O channels on and off. When a device actively supports quiet mode, the device allows its device I/O channels to be controlled either directly on the device, or via the quiet mode protocol (see below).

When a device is in quiet mode it helps to create a quiet zone. A quiet zone is a place where some, or preferably all, of the devices in the vicinity are able, and willing, to respond to a request to put themselves into quiet mode. The cultural equivalent of a quiet zone is a non-smoking area such as a non-smoking house, non-smoking hotel room, non-smoking car, non-smoking office, etc.

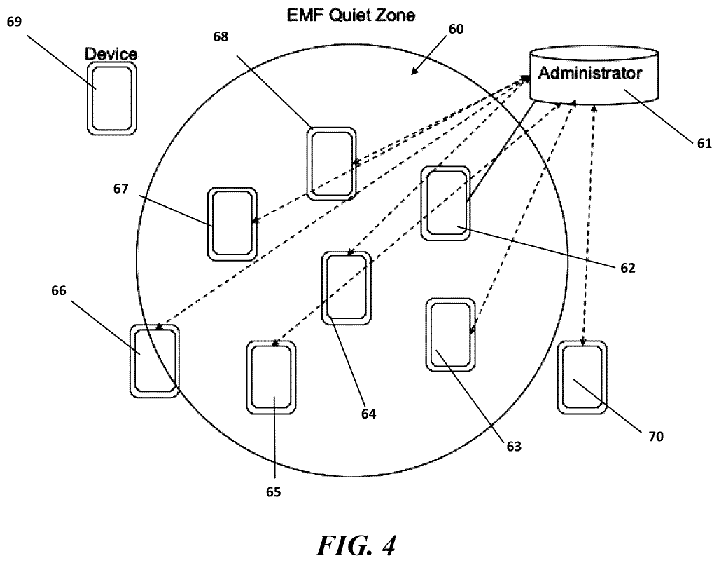

FIG. 4 is a block diagram showing an EMF quiet zone. In FIG. 4, an EMF quiet zone 60, administered by an administrator 61, is shown encompassing several devices 62-68, while devices outside of the EMF quiet zone 69, 70 are not administered.

The EMF quiet zone can throttle or turn some or all of a device's I/O channels on and off using a timer, or other characteristics such as location, time of day, orientation, proximity to others, or until commanded to do so, e.g. via a voice command or API request.

The EMF quiet zone sets the quiet interval of any device I/O channels such that it is throttled or off during the quiet interval, then turns on, performs a check for incoming messages, then turns off again. In embodiments, this interval is based on, but is not limited to, any of the following characteristics:
Fixed time e.g. check every ten minutes.
Dynamic time e.g. check every ten minutes during the workday, every hour outside of work hours.
Location based, e.g. check once when I arrive at work and then every ten minutes while at work, once when I arrive at home then every hour while at home, off at all other locations.
Movement based, e.g. turn off while jogging, check every five minutes while in a car, turn off while in an airplane.
Orientation based, e.g. check automatically when I remove the device from my pocket and look at it.
Voice control, e.g. saying “check now” will cause the device to check now.
Other control options, e.g. the amount of ambient light, whether in night shift mode, the device orientation, accelerometer data, nearby sounds, proximity to others, etc.

When the EMF quiet mode interval expires, some or all of the controlled device's I/O channels are unthrottled or turned on, a check is made for incoming messages on the specified channels, and the channel or channels are throttled or turned off again. After the check is made, the type (email, text, calls, voicemail, etc.) and number of messages is messaged to the user using audio, e.g. using different sounds per incoming message type, device shake, visual display on home screen, etc.

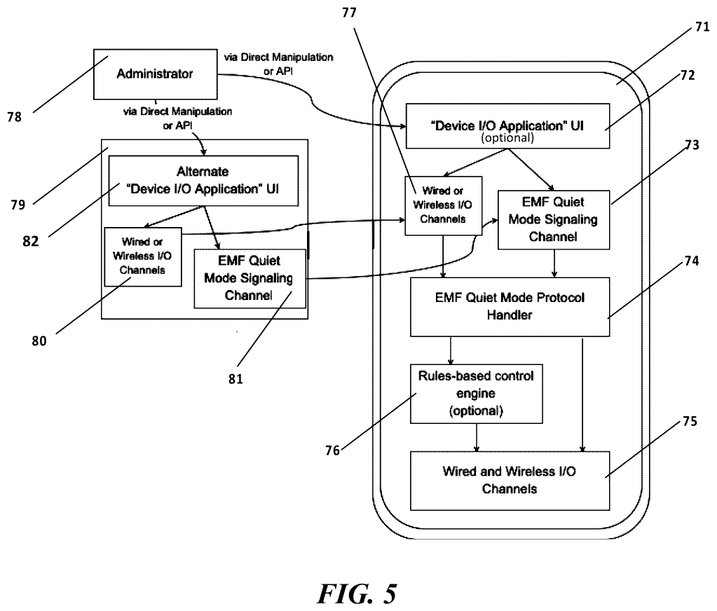

FIG. 5 is a block diagram showing administration of an EMF quiet zone capable device. In FIG. 5, an EMF quiet zone capable device 71 can be controlled by an administrator 78 either by direct manipulation or via an API. The EMF quiet zone capable device may include an optional device I/O application with an optional user interface 72 that responds to such control. The device I/O application may also be controlled by receipt of administrator instructions from an administrator computer 79 that includes an alternate device I/O application UI 82. The EMF quiet zone capable device 71 can also be controlled by an EMF quiet mode protocol that can be delivered either via wired or wireless I/O channels 80 to the device 77, or via an EMF quiet mode signaling channel 81 delivered to the device EMF quiet mode signaling channel 73. An EMF quiet mode protocol handler 74 receives signals from the wireless or wired I/O channels 77 or the EMF quiet mode signaling channel 73 and accesses an optional rules-based control engine 76 as appropriate. The control rules are fired, for example, based on device sensor data (see FIG. 1) or other data. Accordingly, wired and wireless I/O channels 75 within the device are controlled.

### EMF Quiet Zone

An EMF quiet zone is a place where devices are expected to be as digitally silent as possible, based on the level of digital silence defined by the EMF quiet zone administrator. This can range from throttled or “completely off” to something like “intermittent checks are fine as long as they are no more frequent than every five minutes” all the way to something like “no controls are in place from 8 am-5 pm” or “no controls 24 hours a day.” Devices which subscribe to a new EMF quiet mode protocol (see below), allow themselves to be controlled for the purposes of EMF and digital quieting. This allows devices to respect and respond to EMF quiet zones rules.

The EMF quiet mode protocol defines a set of commands and responses that let the EMF quiet zone administrator control devices that enter its sphere of influence, e.g. near or inside a restaurant, daycare, house, building, space, or other location.

An EMF quiet zone introduces the concepts of willing and unwilling devices.
A “willing” device is one which supports EMF quiet mode and is willing and able to engage with other willing devices to create an EMF quiet zone.
An “unwilling” device is either one which does not support EMF quiet mode, i.e. “passive unwilling” devices, or one which does not want to be controlled while in an EMF quiet zone, i.e. “active unwilling” devices.
A willing device can and may allow itself to be controlled by an administrator of an EMF quiet zone, such as in a plane, hospital, bar, restaurant, school, home, etc.
A willing device can be asked to set a “check for messages” schedule that is controlled by the EMF quiet zone administrator.
A willing device can be queried about what mode it is in. For example, all willing student devices can be asked whether they are currently in airplane mode, and a list can be displayed for the teacher with checkmarks next to all students with “willing” devices which are currently “throttled” or “off.”
A willing device can have different privileges based on the class or type of user, e.g. admin, teacher, and student in a school.
A willing device can receive information that is specific to the location, e.g. a company could send information to a willing device about where in the building the cafeteria or gym is, the hours the building is open, etc.
A willing device could receive a coupon or special offer because of the fact that it is willing, e.g. a free coffee for allowing the device to be set to off for the duration of the user's time in the coffee shop.
A willing device can fall into sleep mode when not in use. For example, a Wi-Fi router could be asleep by default, and only awakened via an EMF quiet mode protocol signal when a device wants to use Wi-Fi. While asleep the device waits passively to be told that it is needed, and only then wakes up and announces itself via the standard Wi-Fi protocols.

The administrator of an EMF quiet zone can use any of the rules-based controls provided by the device I/O controller application to set how the devices inside of the EMF quiet zone interact with their own I/O channels. See the discussion of Programmatic Control of Device I/O above for details.

In an embodiment, an individual in an EMF quiet zone has an incoming call but, because the individual's phone has been set to “off,” he cannot receive the call. In this case, when the phone is put into EMF quiet mode, the phone contacts the carrier and lets the carrier know which EMF quiet zone that the individual is in. When the carrier sees an incoming call for that individual, instead of sending it to the individual's phone, the carrier first signals the EMF quiet zone that the individual has an incoming call. The EMF quiet zone then turns the individual's cellular I/O channel to “on,” and informs the carrier that the phone can now accept the incoming call. Embodiments embed this technique into systems as well as devices.

### Quiet Mode Signaling and Quiet Mode Protocol

For the purposes of the discussion herein, two additional concepts are defined:

Quiet mode signaling refers to sending a signal via a channel to the device which understands quiet mode.

A quiet mode protocol is a set of commands by which a device can be controlled. This includes a set of status commands for querying the device's current state, as well as a set of commands for throttling or turning the I/O channels on and off.

### Signaling in Quiet Zones

If one of the purposes of a quiet zone is to block EMF, i.e., wireless radiation, the question turns to how does one signal in a way that does not add additional EMF to the quiet zone? For example, if one wanted to use the existing cellular, or Bluetooth, or Wi-Fi frequencies for signaling, devices would need to have these I/O channels set to “on” to send and receive the control signals, and if those channels are “on” and used for signaling, then it is impossible to create an EMF-free quiet zone. The question then becomes, is it possible to create a signaling protocol that does not add to the already overloaded EMF spectrum. The answer is yes, and the way to do it is to pick a frequency which does no or minimal harm. Not all EMF is bad, and some frequencies are not harmful to humans, animals, or insects, so long as the intensity is kept below a particular threshold. Visible light (from ˜430 THz-˜770 THz) is one such portion of the EMF spectrum which is known to not cause harm to humans, animals, or insects as long as the brightness, i.e. intensity measured in lumens, is kept below the level which causes damage to the retina. Audible sound (from ˜20 Hz-˜20 kHz) is another portion of the EMF spectrum which also does not cause harm to humans, animals, or insects as long as the intensity (measured in dB) is kept below the level which causes either short or long term hearing loss.

As we look more closely at these two parts of the EMF spectrum, we notice each offers distinct trade-offs in range, data capacity, and user disruption.

Light's advantage is that it is very high frequency, which means that digital data can be sent at a very high rate, while its disadvantage is that it does not go around corners unless it is traveling down a fiber optic cable, or is bounced off of mirrors. As such, there is no convenient way to use light to message the router in the next room or the cellular repeater in the closet.

Sound's advantage is that it goes around corners, but its disadvantage is that it is fairly low frequency. As such, the amount of digital data which can be sent is lower than that using light. The other disadvantage of sound is that it would be extremely annoying to hear audio signaling between devices in the human hearing range, especially if there are many devices which are in the EMF quiet zone.

Because light does not go around corners easily, it is necessary to use another portion of the spectrum, and one way to do that would be to use a portion of the spectrum which is close to but outside of human hearing range. In embodiments, we pick a portion of the audio spectrum, which is above human ability to hear, but also one which does not impact animals or insects. It turns out there is a large range above 30 kHz (the upper limit of human hearing), and below 535 kHz (AM radio), which could be used.

### Quiet Mode Signaling

Use a frequency range which does not harm humans, animals, or insects. The exact frequency range is somewhere between about 30 kHz (just above human hearing) and 535 kHz (AM radio). Signaling requires both a sender and a receiver.

Under certain circumstances other frequencies could be acceptable as well. For example, if the quiet mode signaling receiver is able to receive commands passively, i.e. without signaling its presence as is done with Wi-Fi and Bluetooth today, it would be acceptable because it is not adding significant EMF to the quiet zone. Using the human audio range might also be acceptable in certain circumstances as well, e.g. if you wanted to be able to configure your grandmother's device over the phone while you are conversing with her.

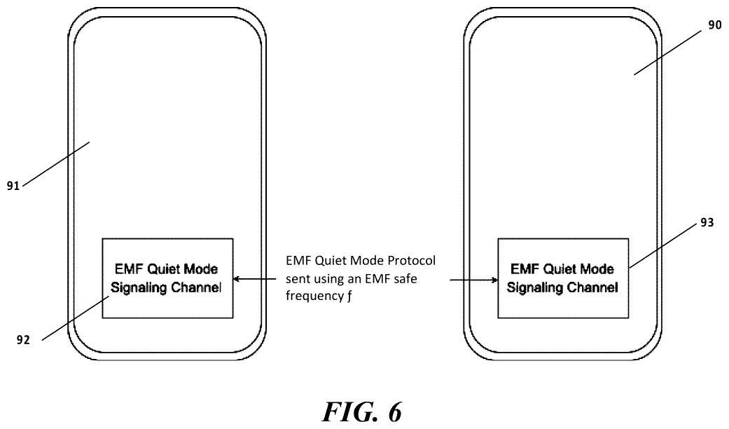

FIG. 6 is a block diagram that shows signaling in EMF quiet zones. In FIG. 6, two devices 90, 91 use EMF safe frequencies for respective EMF quiet mode signaling channels 92, 93. This figure may also represent use cases such as signaling routers and devices in adjacent rooms, using high-frequency or non-EMF signaling to propagate quiet mode rules passively.

### Quiet Mode Protocol

The quiet mode protocol includes a set of commands which can be used to query or set the status of I/O channels on any device which supports quiet mode. The commands can be sent over a wired or wireless connection, or via the quiet mode signaling frequency. The protocol includes commands for both status and control. Status commands allow the protocol to query the device to find out things such as how many I/O channels the device has, how many channels are controllable, what is the current state, e.g. throttled or on vs off, of each channel, whether the device is a willing and smart device, and what version(s) of the protocol it can handle. Control commands allow the protocol to set the state of the device, e.g., “lower the Wi-Fi power to 2,” or “turn the Bluetooth wireless I/O channel off,” or “turn the cellular wireless I/O channel on,” or “tell the cellular wireless I/O channel to turn off and check for incoming messages every ten minutes.”

The quiet mode signaling protocol might use something like TCP/IP to transport the commands, but this might be too much overhead if the frequency is on the lower end of the spectrum. Therefore, the protocol might have multiple modes-a higher frequency mode which uses standard protocols like TCP/IP, and a lower frequency mode which is more on the level of the fax machine protocol, which uses audio tones to denote commands and responses, or other fallback protocols as deemed appropriate. The quiet mode signaling protocol can be broadcast or device-to-device.

A quiet mode device can be a “smart” device or a “dumb” device. A smart device is one which understands rules-based controls such as “turn camera and microphone off at school”, or “check every ten minutes” or “turn off when the airplane is taking off and landing” and is able to execute those rules-based controls itself. A dumb device is one whose I/O channels respond to commands such as “change level” or “turn on” and “turn off,” but does not have the ability to run any rules-based controls itself. These devices require an administrator device which runs the rules engine and sends control signals to the devices it controls as the rules fire.

In short a “smart” device includes onboard logic to independently interpret and apply control rules, whereas a “dumb” device requires external instruction.

### Computer System

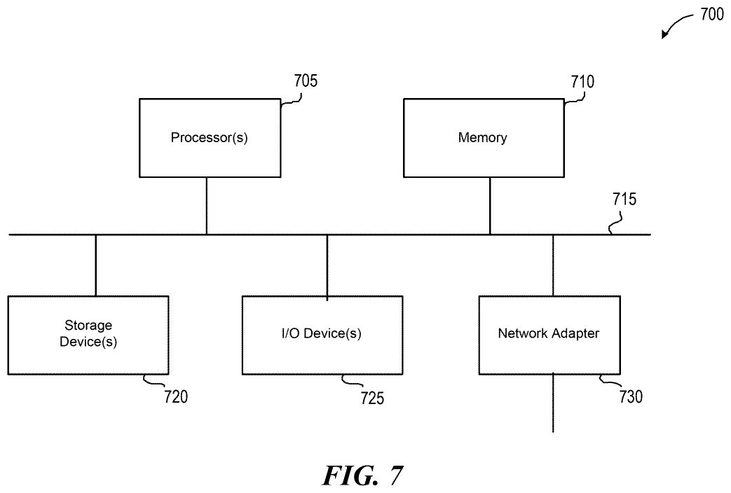

FIG. 7 is a block diagram of a computing system 700 as may be used to implement certain features of some of the embodiments. The computing system 700 may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions (sequential or otherwise) that specify actions to be taken by that machine.

The computing system 700 may include one or more central processing units (“processors”) 705, memory 710, input/output devices 725, e.g. keyboard and pointing devices, touch devices, display devices, storage devices 720, e.g. disk drives, and network adapters 730, e.g. network interfaces, that are connected to an interconnect 715. The interconnect 715 is illustrated as an abstraction that represents any one or more separate physical buses, point to point connections, or both connected by appropriate bridges, adapters, or controllers. The interconnect 715, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called Firewire.

The memory 710 and storage devices 720 are computer-readable storage media that may store instructions that implement at least portions of the various embodiments. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media.

The instructions stored in memory 710 can be implemented as software and/or firmware to program the processor 705 to carry out actions described above. In some embodiments, such software or firmware may be initially provided to the processing system 700 by downloading it from a remote system through the computing system 700, e.g. via network adapter 330.

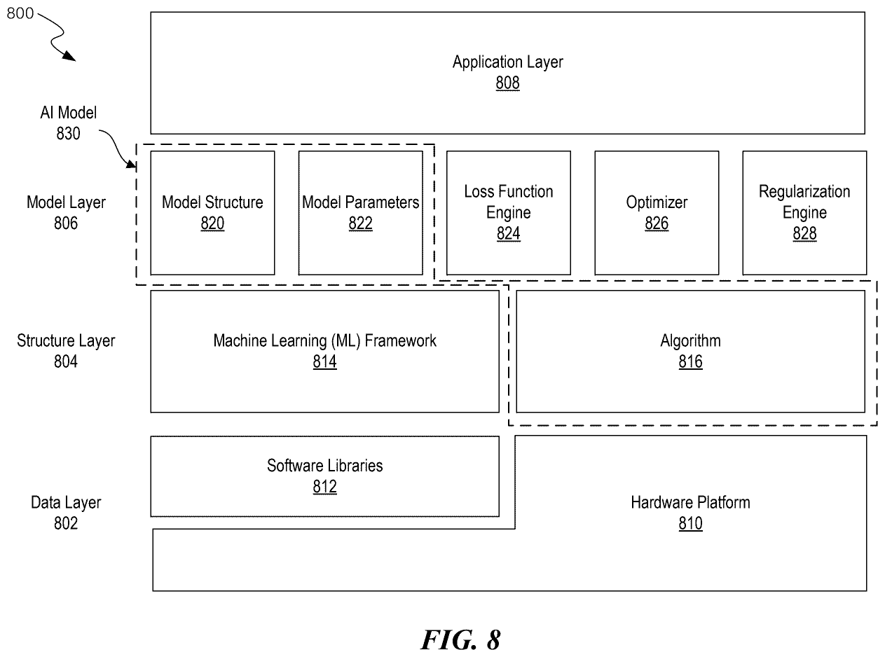

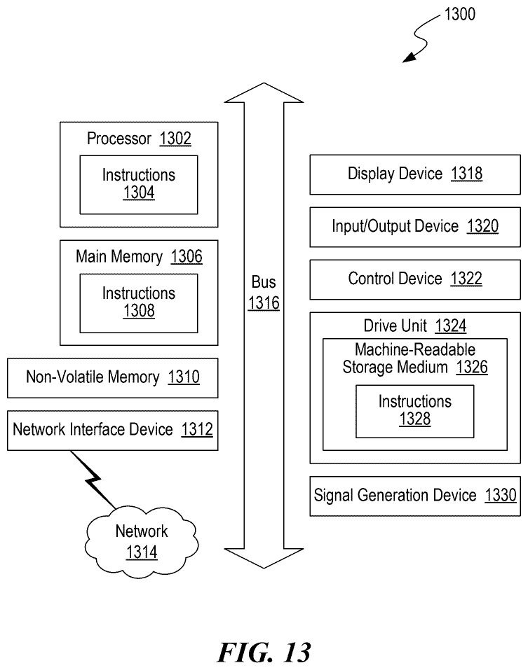

FIG. 8 is a block diagram that illustrates an example AI system 800 that can implement aspects of the present technology. The AI system 800 is implemented using components of the example computer system 1300 illustrated and described in more detail with reference to FIG. 13. For example, the AI system 800 can be implemented on the processor 1302 using instructions 1308 programmed in the memory 1306 illustrated and described in more detail with reference to FIG. 13. Likewise, implementations of the AI system 800 can include different and/or additional components or be connected in different ways. FIG. 8 illustrates a layered architecture of AI system 800 that can implement the AI models of the PROGRAMMATIC CONTROL OF DEVICE I/O; EMF AND ATTENTION REGULATING QUIET MODE, ZONE, SIGNALING, AND PROTOCOL, in accordance with some implementations of the present technology. Accordingly, the device I/O controller application can include one or more components of the AI system 800.

As shown, the AI system 800 can include a set of layers, which conceptually organize elements within an example network topology for the AI system's architecture to implement a particular AI model 830. Generally, an AI model 830 is a computer-executable program implemented by the AI system 800 that analyses data to make predictions. Information can pass through each layer of the AI system 800 to generate outputs for the AI model 830. The layers can include a data layer 802, a structure layer 804, a model layer 806, and an application layer 808. The algorithm 816 of the structure layer 804 and the model structure 820 and model parameters 822 of the model layer 806 together form an example AI model 830. The optimizer 826, loss function engine 824, and regularization engine 828 work to refine and optimize the AI model 830, and the data layer 802 provides resources and support for application of the AI model 830 by the application layer 808.

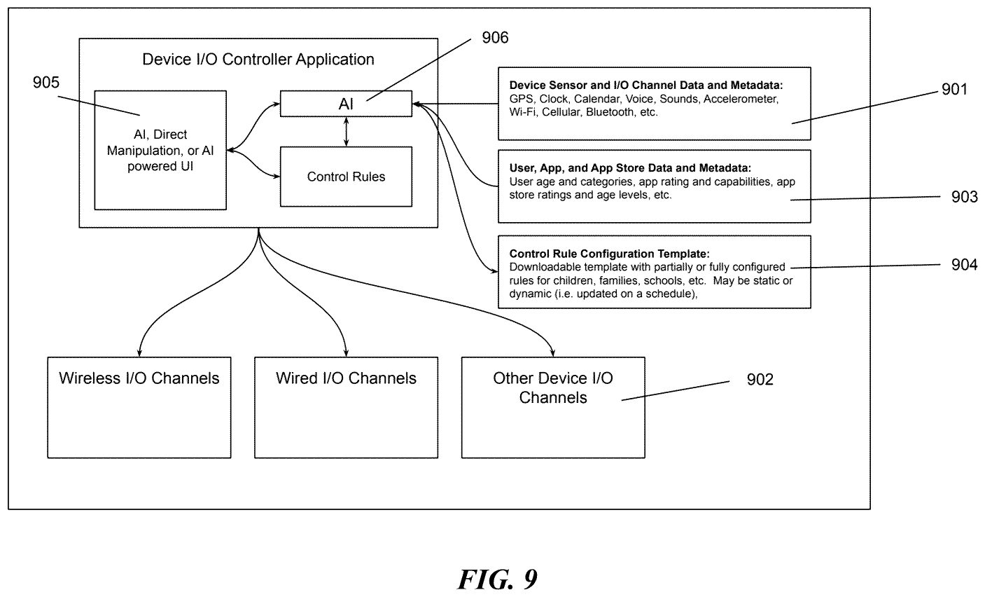

The data layer 802 acts as the foundation of the AI system 800 by preparing data for the AI model 830. As shown, the data layer 802 can include two sub-layers: a hardware platform 810 (e.g., the device 10 described in more detail with reference to FIG. 1) and one or more software libraries 812. The hardware platform 810 can be designed to perform operations for the AI model 830 and include computing resources for storage, memory, logic and networking, such as the resources described in relation to FIG. 9. The hardware platform 810 can process amounts of data using one or more servers. The servers can perform backend operations such as matrix calculations, parallel calculations, machine learning (ML) training, and the like. Examples of servers used by the hardware platform 810 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 810 can include computing resources, (e.g., servers, memory, etc.) offered by a cloud services provider. The hardware platform 810 can also include computer memory for storing data about the AI model 830, application of the AI model 830, and training data for the AI model 830. The computer memory can be a form of random-access memory (RAM), such as dynamic RAM, static RAM, and non-volatile RAM.

The software libraries 812 can be thought of suites of data and programming code, including executables, used to control the computing resources of the hardware platform 810. The programming code can include low-level primitives (e.g., fundamental language elements) that form the foundation of one or more low-level programming languages, such that servers of the hardware platform 810 can use the low-level primitives to carry out specific operations. The low-level programming languages do not require much, if any, abstraction from a computing resource's instruction set architecture, allowing them to run quickly with a small memory footprint. Examples of software libraries 812 that can be included in the AI system 800 include INTEL Math Kernel Library, NVIDIA cuDNN, EIGEN, and OpenBLAS.

The structure layer 804 can include an ML framework 814 and an algorithm 816. The ML framework 814 can be thought of as an interface, library, or tool that allows users to build and deploy the AI model 830. The ML framework 814 can include an open-source library, an application programming interface (API), a gradient-boosting library, an ensemble method, and/or a deep learning toolkit that work with the layers of the AI system facilitate development of the AI model 830. For example, the ML framework 814 can distribute processes for application or training of the AI model 830 across multiple resources in the hardware platform 810. The ML framework 814 can also include a set of pre-built components that have the functionality to implement and train the AI model 830 and allow users to use pre-built functions and classes to construct and train the AI model 830. Thus, the ML framework 814 can be used to facilitate data engineering, development, hyperparameter tuning, testing, and training for the AI model 830. Examples of ML frameworks 814 that can be used in the AI system 800 include TENSORFLOW, PYTORCH, SCIKIT-LEARN, KERAS, LightGBM, RANDOM FOREST, and AMAZON WEB SERVICES.

The algorithm 816 can be an organized set of computer-executable operations used to generate output data from a set of input data and can be described using pseudocode. The algorithm 816 can include complex code that allows the computing resources to learn from new input data and create new/modified outputs based on what was learned. In some implementations, the algorithm 816 can build the AI model 830 through being trained while running computing resources of the hardware platform 810. This training allows the algorithm 816 to make predictions or decisions without being explicitly programmed to do so. Once trained, the algorithm 816 can run at the computing resources as part of the AI model 830 to make predictions or decisions, improve computing resource performance, or perform tasks. The algorithm 816 can be trained using supervised learning, unsupervised learning, semi-supervised learning, and/or reinforcement learning.

Using supervised learning, the algorithm 816 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include native-format data collected from the various computing systems described herein. Furthermore, training data can include pre-processed data generated by the various computing systems described herein. The user may label the training data based on one or more classes and trains the AI model 830 by inputting the training data to the algorithm 816. The algorithm determines how to label the new data based on the labeled training data. The user can facilitate collection, labeling, and/or input via the ML framework 814. In some instances, the user may convert the training data to a set of feature vectors for input to the algorithm 816. Once trained, the user can test the algorithm 816 on new data to determine if the algorithm 816 is predicting accurate labels for the new data. For example, the user can use cross-validation methods to test the accuracy of the algorithm 816 and retrain the algorithm 816 on new training data if the results of the cross-validation are below an accuracy threshold.

Supervised learning can involve classification and/or regression. Classification techniques involve teaching the algorithm 816 to identify a category of new observations based on training data and are used when input data for the algorithm 816 is discrete. Said differently, when learning through classification techniques, the algorithm 816 receives training data labeled with categories (e.g., classes) and determines how features observed in the training data relate to the categories (e.g., a professional context or an educational context). Once trained, the algorithm 816 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 816 is continuous. Regression techniques can be used to train the algorithm 816 to predict or forecast relationships between variables. To train the algorithm 816 using regression techniques, a user can select a regression method for estimating the parameters of the model. The user collects and labels training data that is input to the algorithm 816 such that the algorithm 816 is trained to understand the relationship between data features and the dependent variable(s). Once trained, the algorithm 816 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 816 learns patterns from unlabeled training data. In particular, the algorithm 816 is trained to learn hidden patterns and insights of input data, which can be used for data exploration or for generating new data. Here, the algorithm 816 does not have a predefined output, unlike the labels output when the algorithm 816 is trained using supervised learning. Said another way, unsupervised learning is used to train the algorithm 816 to find an underlying structure of a set of data, group the data according to similarities, and represent that set of data in a compressed format. The control rules processor can use unsupervised learning to identify patterns in digital content history (e.g., to identify when families typically have dinner, when school is in session) and so forth. In some implementations, performance of a generative AI model that can use unsupervised learning is improved because the incoming data from the device sensor data, and application and age level data and metadata is pre-processed and reduced, based on the relevant context, as described herein.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 816 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 816 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of training on the latent variables and that the observable variables have nothing in common after controlling for the latent variables. Examples of latent variable techniques that may be used by the algorithm 816 include factor analysis, item response theory, latent profile analysis, and latent class analysis.

The model layer 806 implements the AI model 830 using data from the data layer and the algorithm 816 and ML framework 814 from the structure layer 804, thus enabling decision-making capabilities of the AI system 800. The model layer 806 includes a model structure 820, model parameters 822, a loss function engine 824, an optimizer 826, and a regularization engine 828.

The model structure 820 describes the architecture of the AI model 830 of the AI system 800. The model structure 820 defines the complexity of the pattern/relationship that the AI model 830 expresses. Examples of structures that can be used as the model structure 820 include decision trees, support vector machines, regression analyses, Bayesian networks, Gaussian processes, genetic algorithms, and artificial neural networks (or, simply, neural networks). The model structure 820 can include a number of structure layers, a number of nodes (or neurons) at each structure layer, and activation functions of each node. Each node's activation function defines how a node converts data received to data output. The structure layers may include an input layer of nodes that receive input data, an output layer of nodes that produce output data. The model structure 820 may include one or more hidden layers of nodes between the input and output layers. The model structure 820 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 822 represent the relationships learned during training and can be used to make predictions and decisions based on input data. The model parameters 822 can weight and bias the nodes and connections of the model structure 820. For instance, when the model structure 820 is a neural network, the model parameters 822 can weight and bias the nodes in each layer of the neural networks, such that the weights determine the strength of the nodes and the biases determine the thresholds for the activation functions of each node. The model parameters 822, in conjunction with the activation functions of the nodes, determine how input data is transformed into desired outputs. The model parameters 822 can be determined and/or altered during training of the algorithm 816.

The loss function engine 824 can determine a loss function, which is a metric used to evaluate the AI model's performance during training. For instance, the loss function engine 824 can measure the difference between a predicted output of the AI model 830 and the actual output of the AI model 830 and is used to guide optimization of the AI model 830 during training to minimize the loss function. The loss function may be presented via the ML framework 814, such that a user can determine whether to retrain or otherwise alter the algorithm 816 if the loss function is over a threshold. In some instances, the algorithm 816 can be retrained automatically if the loss function is greater than the threshold. Examples of loss functions include a binary-cross entropy function, hinge loss function, regression loss function (e.g., mean square error, or quadratic loss), mean absolute error function, smooth mean absolute error function, log-cosh loss function, and quantile loss function.

The optimizer 826 adjusts the model parameters 822 to minimize the loss function during training of the algorithm 816. In other words, the optimizer 826 uses the loss function generated by the loss function engine 824 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 826 used may be determined based on the type of model structure 820 and the size of data and the computing resources available in the data layer 802.

The regularization engine 828 executes regularization operations. Regularization is a technique that prevents over- and under-fitting of the AI model 830. Overfitting occurs when the algorithm 816 is overly complex and too adapted to the training data, which can result in poor performance of the AI model 830. Underfitting occurs when the algorithm 816 is unable to recognize even basic patterns from the training data such that it cannot perform well on training data or on validation data. The optimizer 826 can apply one or more regularization techniques to fit the algorithm 816 to the training data properly, which helps constraint the resulting AI model 830 and improves its ability for generalized application. Examples of regularization techniques include lasso (L1) regularization, ridge (L2) regularization, and elastic (L1 and L2 regularization).

The application layer 808 describes how the AI system 800 is used to solve problems or perform tasks. In an example implementation, the application layer 808 can include the device I/O controller application UI and control rules.

FIG. 9 is a block diagram showing a user device and device I/O controller application. Device I/O 901 encompasses any mechanism or subsystem through which a device receives input or delivers output, such as physical or virtual interfaces, sensors, actuators, user interaction elements (e.g., cameras, microphones, speakers, screens, touch input), and system-level outputs such as vibrations, beeps, notifications, visual alerts, or haptic feedback. This definition is intended to be inclusive of all modalities of device interaction 902, whether hardware- or software-based, local or networked, analog or digital.

In some embodiments, control rules may incorporate rating metadata associated with digital content such as advertisements, video clips, audio streams, and podcasts. This metadata may originate from content platforms, regulatory frameworks, or third-party classifiers, and can include age ratings, sensitivity flags, content type identifiers (e.g., violent, sexual, political), or educational tags. The device I/O controller application may use this metadata to enforce restrictions such as “do not play ad content rated for age 16+ for users under age 13,” or “block access to political ads during school hours.” These rules can be applied dynamically, based on the user profile and current context.

903 shows the use of data and metadata such as age and category information as defined by parents, schools, administrators, as well as the use of application and App Store data and metadata, as additional inputs to control rules. Data and metadata may be obtained via app marketplace APIs or local app manifest inspection, and used to enforce rules based on parental control levels, age ratings, or content categories, and may be pulled in real-time or at install time. And the control rules may compare this against known parental ratings and device usage logs.

Control rules may further incorporate privacy-related app behaviors, including requests for user data such as contacts, photos, location, or microphone access, and patterns of transmitting such data to remote servers. The device I/O controller application may inspect app permission requests, app manifest data, and observed network activity to identify apps that access sensitive data or engage in background data transfer. Rules may then restrict installation, launch, or I/O activity for apps that (a) request access to protected user data without appropriate context or consent, or (b) transmit user data to remote endpoints without explicit approval.

In some embodiments, the device I/O controller application enforces a default-deny policy for all newly requested permissions by installed applications. Upon detection of a new permission request—such as access to contacts, microphone, camera, photos, or location—the system blocks the permission by default and routes the request to the appropriate supervising entity (e.g., parent, teacher, or institutional administrator) for review and approval.

In further embodiments, all permission request events and associated metadata (e.g., app identity, requested permission type, time, context) are logged and transmitted—subject to anonymization and privacy safeguards—to a central analytics server. This server aggregates data across users and devices to identify applications that systematically request excessive or privacy-invasive permissions, engage in unauthorized background data transfer, or exhibit behavior inconsistent with published app metadata. The system may generate periodic reports for parents, schools, or regulatory entities, flagging potentially non-compliant or deceptive app behaviors.

The control rules engine may inspect or retrieve application data and metadata to determine whether an app contains features such as autoplay, frequent notifications, or real-time messaging. Rules can then enforce limitations or suspensions of these behaviors in attention-regulated contexts. For example, a video app with an “autoplay” feature may be restricted to single-play mode, or messaging apps may have alerts disabled temporarily.

A configuration template 904 allows users, administrators, or institutions to define reusable rule sets or profiles-such as “school hours,” “sleep mode,” or “family dinner”—that can be quickly applied across one or more devices. These templates may include predefined combinations of time-based, location-based, or activity-based rules, and may optionally be customized or layered with additional context-aware inputs. Static and dynamic rules and templates enable rapid deployment of common quieting behaviors across devices, simplifying adoption of device quiet mode for EMF reduction, attention regulation, or institutional compliance. Rules and templates may require administrator privileges before they can be replaced, removed or overridden by users, APIs, proxy connections, etc.

The device I/O controller may incorporate AI to power the UI 905, or AI models 906 to predict optimal quiet schedules personalized to the user, based on past usage, biological rhythms (e.g., sleep/wake cycles), or focus periods. These predictive schedules can improve attention outcomes or EMF mitigation without requiring active user intervention.

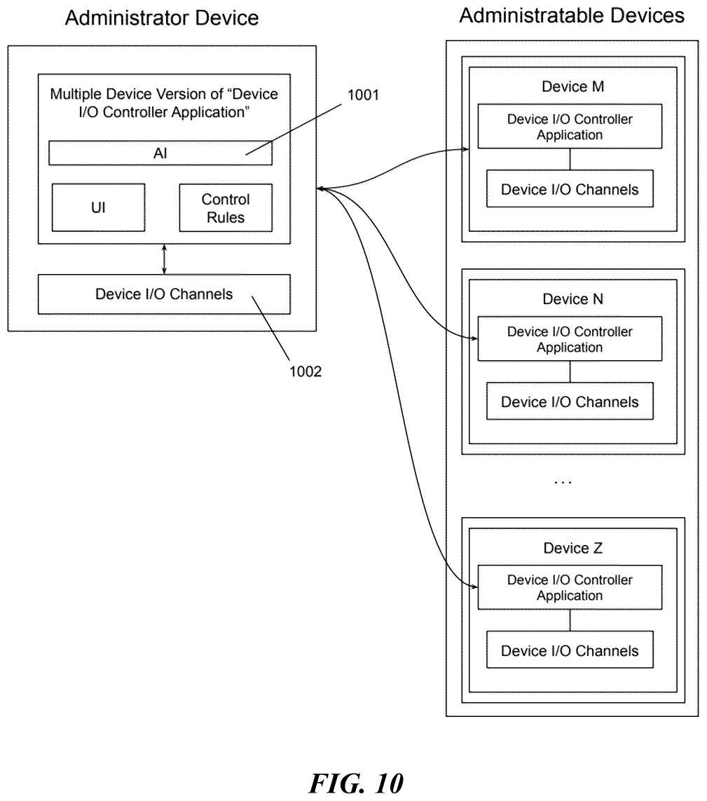

FIG. 10 is a block diagram showing device administration. In FIG. 10, the device I/O controller may incorporate AI 1001 to power the application, the UI, or the control rules. The controller can also control any or all device I/O channels 1002 on the administrator or any of the administrable devices. Rules and templates may require administrator privileges before they can be replaced, removed or overridden by users, APIs, proxy connections, etc. An AI-based anomaly detection module may flag patterns that suggest policy circumvention or unusual device behavior, enabling administrators to take corrective action or dynamically lock down high-risk settings or users.

FIG. 10 depicts an administrator device that includes a multiple-device version of a device I/O controller application. The application incorporates AI functionality 1001 that may be used to control the application, user interface, and control rules. The administrator device interfaces with device I/O channels 1002 which enable communication with and control of administrable devices. The administrator device includes a processor and non-transitory memory storing instructions for implementing the device I/O controller application. The device I/O controller application receives a set of control rules for managing I/O channels of administrable devices. These control rules may be stored in the non-transitory memory of the administrator device.

In operation, the device I/O controller application monitors device sensor data and application metadata from the administrable devices via the device I/O channels 1002. The device sensor data may include information such as location, motion, ambient light levels, or other contextual information. Application metadata may include details about installed applications, their usage patterns, and permissions. Based on the monitored device sensor data and application metadata, the device I/O controller application determines whether any control rules have been triggered. For example, a rule may be triggered if an administrable device enters a specific location or if a particular application is launched during restricted hours.

When the device I/O controller application determines that a control rule has been triggered, the application programmatically adjusts at least one I/O channel of the relevant administrable device. This adjustment may involve throttling the I/O channel to regulate attention disruptions. For example, the system dynamically modulates I/O channel activity based on predefined thresholds and contextual analysis. It employs adaptive filtering algorithms to suppress non-critical notifications, throttles data streams, and implements temporal partitioning of device functions to minimize cognitive load and attentional capture. The device I/O controller application may reduce the frequency of notifications or limit access to certain applications during designated quiet hours. The device I/O channels 1002 that may be controlled include various input and output mechanisms of the administrable devices. These may encompass wireless communication channels, display settings, audio outputs, and notably, notification systems. The ability to control notifications allows the administrator device to manage potential sources of distraction across multiple administrable devices.

The device I/O controller application incorporates a configuration template feature for defining reusable rule sets or profiles. These templates allow administrators to create standardized policies that may be applied consistently across multiple administrable devices. For example, a “school hours” template may define a set of I/O restrictions appropriate for classroom environments. To implement these templates, the device I/O controller application accesses a configuration template that defines a reusable set of rule combinations for managing the I/O channels. The application then applies this configuration template across multiple administrable devices, providing more consistent I/O channel management policies throughout the administered network.

The AI functionality 1001 in the administrator device enhances the capabilities of the device I/O controller application. The AI may analyze patterns in device usage, rule effectiveness, and user behavior to suggest optimizations to the control rules or configuration templates. For example, the AI may identify periods of high productivity and recommend adjusting quiet hours to align with these times. The diagram shows multiple administrable devices, labeled as Device M through Device Z, arranged vertically. Each administrable device contains its own device I/O controller application and device I/O channels. The administrator device communicates with and controls these administrable devices through the device I/O channels 1002.

In some cases, the AI functionality 1001 may process inputs from multiple administrable devices to identify broader patterns or trends. This aggregated analysis may inform more sophisticated, context-aware control policies that adapt to changing conditions across the entire network of administered devices. The system architecture illustrated in FIG. 10 enables centralized, intelligent management of multiple devices' I/O behaviors. By leveraging AI capabilities and flexible configuration templates, the administrator device may implement nuanced, adaptive control policies that balance productivity, attention management, and user needs across a diverse set of administrable devices.

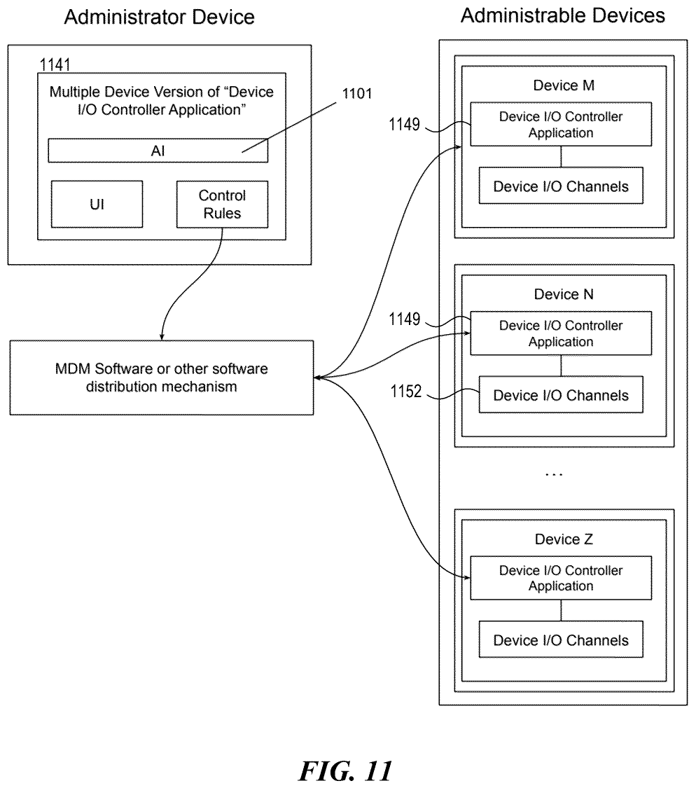

FIG. 11 is a block diagram showing corporate device administration. FIG. 11 shows the use of AI 1101 on the administrator device, which can be used to control the UI, the Control Rules, or control how and when the MDM software modifies, updates and distributes rules to administrable devices. FIG. 11 depicts an administrator device and multiple administrable devices. The administrator device contains a multiple-device version of a device I/O controller application 1141 that includes an AI 1101, a user interface (UI), and control rules. The device I/O controller application 1141 connects to MDM software or other software distribution mechanism.

The system includes multiple administrable devices, labeled as Device M through Device Z. Each administrable device contains a device I/O controller application 1149 and device I/O channels 1152. The MDM software or other software distribution mechanism connects to the administrable devices to enable communication and control. The device I/O controller application 1141 in the administrator device may receive and store a set of control rules for managing the device I/O channels 1152 of the administrable devices. These control rules may include time-based rules, location-based rules, activity-based rules, voice-based rules, sensor-based rules, user age-based rules, and application category-based rules.

In operation, the device I/O controller application 1141 may monitor device sensor data and application metadata from the administrable devices. The device sensor data may include GPS data, clock data, calendar data, voice data, sound data, accelerometer data, Wi-Fi data, cellular data, or Bluetooth data. Application metadata may include age ratings, content type identifiers, or parental guidance flags. Based on the monitored data, the device I/O controller application 1141 may determine if any control rules have been triggered. For example, the system iteratively evaluates Boolean conditions defined in control rules against real-time device sensor data and metadata. When a condition evaluates to true, the corresponding rule is flagged as triggered, prompting execution of associated I/O channel adjustments or policy enforcement actions. When a rule is triggered, the application may programmatically adjust at least one of the device I/O channels 1152 on the relevant administrable device. The device I/O channels 1152 may include cellular channels, Wi-Fi channels, Bluetooth channels, microphones, speakers, cameras, or notification systems.

The adjustment of a device I/O channel 1152 may involve turning off the channel, limiting functionality of the channel, or modifying settings of the channel. Limiting functionality may involve restricting or disabling specific features, reducing performance, capping data usage, decreasing update frequency, shortening session durations, or constraining access to certain resources or services on a device or application. For example, the device I/O controller application 1141 may disable notifications during designated quiet hours or limit access to certain applications based on user age. In some cases, the device I/O controller application 1141 may create and maintain user profiles for the administrable devices. These profiles may include user preferences and usage patterns. The application may dynamically update these profiles based on monitored user interactions with the devices.

In some embodiments, programmatically adjusting at least one I/O channel of the device includes suppressing application-level behaviors by selectively disabling or modifying specific functionalities of applications installed on the device, based on control rules triggered by contextual analysis. The device I/O controller application mediates these behaviors by interfacing with operating system-level permission frameworks, accessibility services, or app configuration settings to programmatically inhibit operations such as autoplay of media content, generation of push notifications, background synchronization of data, polling of device location, or transmission of message alerts. This app-level mediation may occur in addition to or independently of system-level I/O throttling. The suppression logic is informed by contextual inputs such as user age, application metadata (e.g., category or age rating), and environmental cues, allowing for dynamic enforcement of attention-regulating or EMF-reducing behaviors. For example, during predicted periods of focus, the controller may disable push notifications and mute autoplay for entertainment apps, while allowing essential communications to persist under administrative or user-defined exceptions.

The device I/O controller applications 1149 in the administrable devices may enforce a default-deny policy for all newly requested permissions by installed applications. When an application requests a new permission, the device I/O controller application 1149 may block the request by default and route it to an appropriate supervising entity for review. The device I/O controller application 1141 may also log and transmit permission request events and associated metadata to a central analytics server. This data may be used to identify applications that request excessive or privacy-invasive permissions.

The AI 1101 in the administrator device may analyze patterns in device usage, rule effectiveness, and user behavior across the administrable devices. Based on this analysis, the AI 1101 may suggest optimizations to the control rules or generate new rules tailored to specific users or groups. The system architecture illustrated in FIG. 11 enables centralized, intelligent management of multiple devices' I/O behaviors in a corporate setting. By leveraging AI capabilities and flexible control rules, the administrator device may implement nuanced, adaptive control policies that balance productivity, privacy, and institutional compliance across a diverse set of administrable devices.

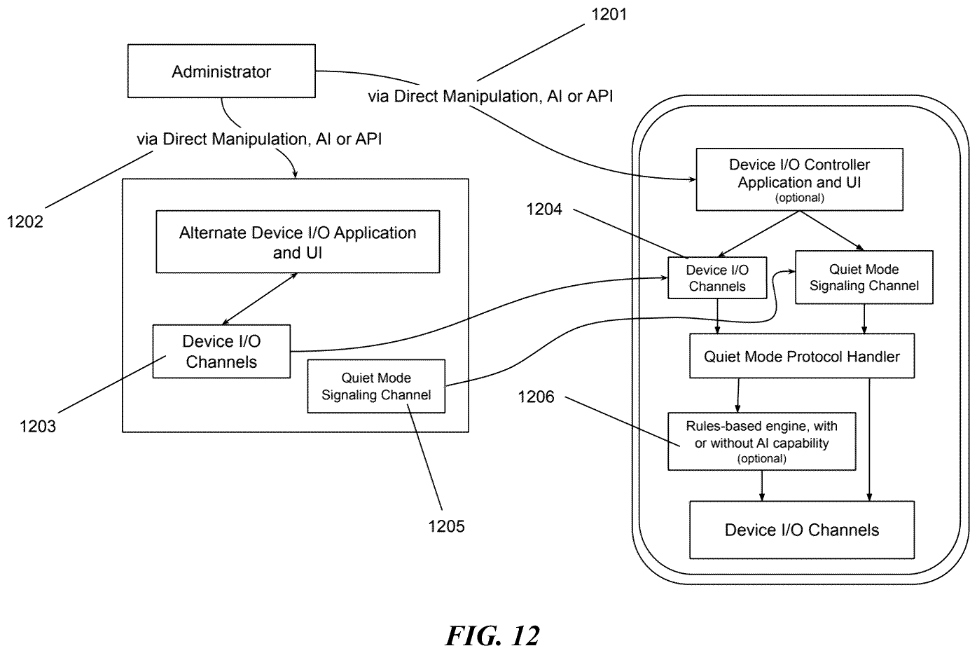

FIG. 12 is a block diagram showing administration of a quiet zone capable device. FIG. 12 is an updated version of FIG. 5, showing the use of AI 1201, 1202 as part of the administration process, controlling device I/O channels 1203, 1204, using a Quiet Mode Signaling Channel 1205, and a rules based engine 1206 which can include an AI component.

The system incorporates a first AI component 1201 that interfaces with administrative functions. A second AI component 1202 connects to the device I/O channels 1203. The device I/O channels 1203, 1204 provide pathways for implementing control policies and managing device functionality. The quiet mode signaling channel 1205 connects to the rules based engine 1206 to enable coordination of quiet mode settings and behaviors. In some cases, the quiet mode signaling channel 1205 may operate in a frequency range between 30 kHz and 535 kHz. This frequency range allows for signaling without adding significant electromagnetic field (EMF) emissions to the quiet zone.

The AI components 1201, 1202 may be used to detect and classify contextual cues. For example, the AI components 1201, 1202 may identify when a user is in a “deep work” state by analyzing inputs from the device I/O channels 1203, 1204 such as app usage patterns, typing cadence, or ambient audio levels. The rules based engine 1206 may process inputs from the AI components 1201, 1202 and the device I/O channels 1203, 1204 to generate a predictive quiet schedule. A predictive quiet schedule may dynamically adjust device I/O settings based on AI-generated forecasts of optimal quiet periods, utilizing historical usage data, user behavior patterns, environmental cues, and contextual information to anticipate when reduced connectivity is beneficial. This schedule may be based on historical usage patterns and user context. Historical usage patterns and user context may include data on device interactions, app usage frequency and duration, time-of-day patterns, location-based behaviors, social interactions, productivity metrics, and physiological indicators. This information can be collected over time to identify trends, preferences, and habits specific to individual users or user groups in various situations and environments. The predictive quiet schedule may then be applied to automatically adjust the device I/O channels 1203, 1204 during predicted periods of user focus or rest.

In some implementations, the rules based engine 1206 may classify devices as “willing” or “unwilling” participants in a quiet zone. This classification may be based on whether a device supports the quiet mode protocol implemented through the quiet mode signaling channel 1205. The rules based engine 1206 may extend control beyond system-level I/O channels to mediate behaviors within applications themselves. For example, the rules based engine 1206 may suspend autoplay video functionality or suppress push notifications for certain applications during quiet mode periods.

In some embodiments, said adjusting is performed only when the device is identified as a willing participant in an administrator-defined protocol, ensuring compliance with predefined quiet mode governance. The willingness of a device is determined by evaluating whether it supports a quiet mode signaling protocol—such as a low-EMF signaling method operating in the 30 kHz to 535 KHz frequency range—and whether it has accepted or been configured to receive administrator-issued control rules. Upon detection of an applicable signaling message and validation of protocol compatibility, the device registers itself as an active and responsive node within the quiet zone or protocol domain. Only then does the device I/O controller application proceed to apply the relevant control rules to throttle or suppress I/O activity. This architecture allows differentiation between compliant and non-compliant devices in a shared environment, such as a classroom, hospital, or theater, enabling selective enforcement of attention-regulating or EMF-reducing measures across an administrated device ecosystem.

In certain embodiments, transmitting and receiving signaling messages associated with a control rule is performed using a quiet mode protocol that operates within a designated electromagnetic frequency range selected to minimize EMF exposure while maintaining robust local communication. Specifically, the protocol may utilize frequencies in the sub-MHz band, such as between 30 KHz and 535 kHz, which lie above the range of human hearing but below conventional radio frequencies. These signaling messages may encode administrative directives, device participation status, or synchronization data to coordinate the activation or suppression of I/O channels among compliant devices within a designated quiet zone. Transmission may occur through hardware-integrated signaling components or low-frequency modulation of existing communication interfaces. Upon receiving a valid quiet mode signal, a device verifies the protocol version and evaluates its assigned ruleset before applying any changes. This signaling mechanism enables low-power, non-intrusive, and spatially targeted propagation of control rules, supporting EMF-safe administration of context-sensitive device behavior.

Additionally, the rules based engine 1206 may incorporate privacy-related app behaviors when determining control rules. This may involve analyzing app permission requests, data transmission patterns, or other privacy-sensitive activities detected through the device I/O channels 1203, 1204. The system components are arranged to show the flow of control signals and data between the AI components 1201, 1202, device I/O channels 1203, 1204, quiet mode signaling channel 1205, and rules based engine 1206. This architecture enables programmatic control of device I/O functionality through the coordinated operation of these components, allowing for sophisticated management of quiet zones and attention regulation.

In some implementations, a method for programmatically controlling device I/O channels includes receiving, by a device I/O controller application, a set of control rules for managing I/O channels of a device. For example, the device I/O controller application receives control rules—based on time, location, activity, or AI-inferred context—that are evaluated using sensor data and user profiles. The application can invoke device APIs to adjust the operational state of selected I/O channels, such as Wi-Fi, Bluetooth, microphone, or camera, to reduce EMF exposure or support attention-regulating objectives. The device I/O controller application monitors device sensor data and application metadata. For example, the device sensor data includes accelerometer, ambient light, and orientation inputs, and the application metadata includes app category, age rating, and permission requests. This real-time monitoring enables the application to assess contextual conditions and user behavior, facilitating dynamic enforcement of control rules across the device's I/O channels.

Based on the monitored device sensor data and application metadata, it is determined that a control rule from the set of control rules has been triggered. AI can be used to perform this determining step. For example, using one or more AI models trained on historical sensor inputs, app usage patterns, and contextual feedback, the device I/O controller application analyzes real-time sensor data and application metadata to infer user context. The AI framework classifies states such as focused attention, social interaction, or sleep, and correlates these with predefined or dynamically generated control rules. When the AI model identifies a context that satisfies the triggering conditions of a rule, the system determines that the corresponding control rule has been activated. In response to determining that the control rule has been triggered, the device I/O controller application programmatically adjusts at least one I/O channel of the device. For example, upon determining that a control rule has been triggered, the device I/O controller application invokes system-level APIs to adjust at least one I/O channel, such as disabling Wi-Fi or muting notifications. The adjusting includes throttling the at least one I/O channel to regulate attention disruptions. For example, throttling the selected I/O channel can limit notification frequency or delay message retrieval intervals to reduce attention disruptions based on context inferred from sensor and metadata inputs.

Further, an AI model can be used to generate a predictive quiet schedule based on historical usage patterns and user context. For example, the AI model generates a predictive quiet schedule by analyzing historical device usage patterns, sensor-derived context, and application metadata. The AI model infers periods of likely cognitive demand or rest and anticipates future attention-sensitive intervals, producing a schedule that programmatically modulates I/O channels to reduce EMF exposure and minimize digital interruptions. The predictive quiet schedule is applied to automatically adjust the at least one I/O channel during predicted periods of user focus or rest. For example, the device I/O controller application applies the predictive quiet schedule by invoking system-level or application APIs at scheduled intervals to throttle or disable specified I/O channels-such as muting notifications, pausing background data sync, or restricting wireless interfaces-during anticipated periods of user focus or rest, enforcing context-aware quiet mode.

FIG. 13 is a block diagram that illustrates an example of a computer system 1300 in which at least some operations described herein can be implemented. As shown, the computer system 1300 can include: one or more processors 1302, main memory 1306, non-volatile memory 1310, a network interface device 1312, video display device 1318, an input/output device 1320, a control device 1322 (e.g., keyboard and pointing device), a drive unit 1324 that includes a storage medium 1326, and a signal generation device 1330 that are communicatively connected to a bus 1316. The bus 1316 represents one or more physical buses and/or point-to-point connections that are connected by appropriate bridges, adapters, or controllers. Various common components (e.g., cache memory) are omitted from FIG. 13 for brevity. Instead, the computer system 1300 is intended to illustrate a hardware device on which components illustrated or described relative to the examples of the figures and any other components described in this specification can be implemented.

The computer system 1300 can take any suitable physical form. For example, the computer system 1300 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 1300. In some implementation, the computer system 1300 can be an embedded computer system, a system-on-chip (SOC), a single-board computer system (SBC) or a distributed system such as a mesh of computer systems or include one or more cloud components in one or more networks. Where appropriate, one or more computer systems 1300 can perform operations in real-time, near real-time, or in batch mode.

The network interface device 1312 enables the computer system 1300 to mediate data in a network 1314 with an entity that is external to the computer system 1300 through any communication protocol supported by the computer system 1300 and the external entity. Examples of the network interface device 1312 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 1306, non-volatile memory 1310, machine-readable medium 1326) can be local, remote, or distributed. Although shown as a single medium, the machine-readable medium 1326 can include multiple media (e.g., a centralized/distributed database and/or associated caches and servers) that store one or more sets of instructions 1328. The machine-readable (storage) medium 1326 can include any medium that is capable of storing, encoding, or carrying a set of instructions for execution by the computer system 1300. The machine-readable medium 1326 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1310, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1304, 1308, 1328) set at various times in various memory and storage devices in computing device(s). When read and executed by the processor 1302, the instruction(s) cause the computer system 1300 to perform operations to execute elements involving the various aspects of the disclosure.

The various embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

I/We claim:

1. A method for programmatically controlling device input/output (I/O) channels, comprising:
receiving, by a device I/O controller application, a set of control rules for managing I/O channels of a device;
monitoring, by the device I/O controller application, device sensor data and application metadata;
determining, based on the monitored device sensor data and application metadata, that a control rule from the set of control rules has been triggered; and
in response to determining that the control rule has been triggered,
programmatically adjusting, by the device I/O controller application, at least one I/O channel of the device,
wherein said adjusting comprises throttling the at least one I/O channel to regulate attention disruptions.

2. The method of claim 1, wherein the device sensor data comprises at least one of: GPS data, clock data, calendar data, voice data, sound data, accelerometer data, Wi-Fi data, cellular data, or Bluetooth data.

3. The method of claim 1, wherein the application metadata comprises at least one of: age ratings, content type identifiers, or parental guidance flags.

4. The method of claim 1, wherein the set of control rules includes at least one of: time-based rules, location-based rules, activity-based rules, voice-based rules, sensor-based rules, user age-based rules, or application category-based rules.

5. The method of claim 1, wherein said adjusting comprises at least one of: turning off the at least one I/O channel, limiting functionality of the at least one I/O channel, or modifying settings of the I/O channel.

6. The method of claim 1, wherein the at least one I/O channel comprises at least one of: a cellular channel, a Wi-Fi channel, a Bluetooth channel, a microphone, a speaker, a camera, and a notification system.

7. The method of claim 1, further comprising:
generating, by an artificial intelligence (AI) model, a predictive quiet schedule based on historical usage patterns and user context; and
applying the predictive quiet schedule to automatically adjust the at least one I/O channel during predicted periods of user focus or rest.

8. A computer system for programmatically controlling device input/output (I/O) channels, comprising:
a processor; and
a non-transitory memory storing instructions that, when executed by the processor, cause the computer system to:
store a set of control rules for managing I/O channels of a device;
monitor sensor data and application metadata of the device;
determine, based on the monitored sensor data and application metadata, that a control rule from the set of control rules has been triggered; and
in response to determining that the control rule has been triggered, programmatically adjust at least one I/O channel of the device,
wherein the programmatic adjustment comprises throttling the at least one I/O channel to regulate attention disruptions.

9. The computer system of claim 8, wherein the set of control rules includes policy-based rules that enforce device usage restrictions based on institutional policies,
wherein the institutional policies comprise at least one of: school policies, corporate policies, parental control policies, or regulatory compliance policies.

10. The computer system of claim 8, wherein the instructions further cause the computer system to:
access a configuration template that defines a reusable set of rule combinations for managing the I/O channels; and
apply the configuration template across multiple devices to implement consistent I/O channel management policies.

11. The computer system of claim 8, wherein the instructions further cause the computer system to:
create a user profile that includes user preferences and usage patterns;
adjust the set of control rules based on the user profile; and
dynamically update the user profile based on monitored user interactions with the device.

12. The computer system of claim 8, wherein said adjusting comprises at least one of: turning off the I/O channel, limiting functionality of the I/O channel, or adjusting settings of the I/O channel.

13. The computer system of claim 8, wherein the at least one I/O channel comprises at least one of: a cellular channel, a Wi-Fi channel, a Bluetooth channel, a microphone, a speaker, a camera, and a notification system.

14. The computer system of claim 8, wherein the memory stores further instructions that, when executed by the processor, cause the computer system to:
generate, by an artificial intelligence (AI) model, a predictive quiet schedule based on historical usage patterns and user context; and
apply the predictive quiet schedule to automatically adjust the at least one I/O channel during predicted periods of user focus or rest.

15. A non-transitory computer-readable medium storing instructions that, when executed by a processor, cause the processor to perform a method for programmatically controlling device input/output (I/O) channels, the method comprising:
receiving a set of control rules for managing I/O channels of a device;
monitoring device sensor data and application metadata;
determining, based on the monitored device sensor data and application metadata, that a control rule from the set of control rules has been triggered; and
in response to determining that the control rule has been triggered, programmatically adjusting at least one I/O channel of the device, wherein the programmatic adjustment comprises throttling the at least one I/O channel to regulate attention disruptions.

16. The non-transitory computer-readable medium of claim 15, wherein the device sensor data comprises at least one of: GPS data, clock data, calendar data, voice data, sound data, accelerometer data, Wi-Fi data, cellular data, and Bluetooth data.

17. The non-transitory computer-readable medium of claim 15, wherein the application metadata comprises at least one of: age ratings, content type identifiers, and parental guidance flags.

18. The non-transitory computer-readable medium of claim 15, wherein said adjusting comprises suppressing application-level behaviors by disabling or modifying one or more functionalities of an application installed on the device, the functionalities comprising at least one of: autoplay of media content, generation of push notifications, background data synchronization, location polling, or message alerts.

19. The non-transitory computer-readable medium of claim 15, wherein said adjusting is performed only if the device is identified as a willing participant in an administrator-defined protocol, the willingness determined based on the device's support for a quiet mode signaling protocol and acceptance of administrator-issued control rules.

20. The non-transitory computer-readable medium of claim 15, wherein the method further comprises:
transmitting and receiving signaling messages associated with the control rule using a quiet mode protocol that operates within a particular electromagnetic frequency range.
